(19) United States
(12) Patent Application Publication
(10) Pub. No.: US 2020/0334767 A1
(43) Pub. Date: Oct. 22, 2020

(54) SYSTEMS AND METHODS FOR USING INFORMATION OBTAINED THROUGH TIME-LIMITED EVENTS AMONG QUICK SERVICE RESTAURANTS

(71) Applicant: HM ELECTRONICS, INC., Poway, CA (US)

(72) Inventors: James Thomas Silane, San Diego, CA (US); David Kenneth Mattox, Temecula, CA (US)

(21) Appl. No.: 16/385,631

(22) Filed: Apr. 16, 2019

(51) Int. Cl. G06Q 50/12; G06Q 10/06; G06N 5/02

(52) U.S. Cl. CPC G06Q 50/12; G06N 5/02; G06Q 10/06393

(57) ABSTRACT

Systems and methods for using information obtained through time-limited events among quick service restaurants are disclosed. Exemplary implementations may: obtain sets of values of one or more service metrics that are related to service durations at a first quick service restaurant; analyze the obtained set of values to determine one or more effects that are attributed to holding the first time-limited event; determine a first recommendation for a future time-limited event to be held; and effectuate a first presentation to an event administrator.

### FIELD OF THE DISCLOSURE

The present disclosure relates to systems and methods for using information obtained through time-limited events among quick service restaurants, and, for example, for improving service metrics of the quick service restaurants.

### BACKGROUND

Quick service restaurants are known. Measuring how long it takes to provide service to individual customers at quick service restaurants is known. Comparing performance measurements between, e.g., employees, is known.

### SUMMARY

One aspect of the present disclosure relates to a system configured for using information obtained through time-limited events among quick service restaurants. The system may include one or more hardware processors configured by machine-readable instructions. The processor(s) may be configured to obtain sets of values of one or more service metrics that are related to service durations at a first quick service restaurant. Individual sets of values may correspond to individual periods (e.g., day parts, days, weeks, months, years, etc.) during which the values may have been determined at the first quick service restaurant. The sets may include a first set, a second set, and/or other sets. The first set may correspond to a first period (e.g., a week or a month) that occurred before a first time-limited event (e.g., a week-long contest). The second set may correspond to a second period that occurred after the first period (e.g., the week or month after the contest). The processor(s) may be configured to analyze the obtained set of values to determine one or more effects that are attributed to holding the first time-limited event (e.g., a decrease in the average service duration for vehicles in a drive-thru). Individual ones of the one or more effects may correspond to one or more changes in the values of the one or more service metrics between the first set and the second set. The processor(s) may be configured to determine a first recommendation for a future time-limited event to be held (e.g., a different contest). Participants of the future time-limited event may include the first quick service restaurant. The first recommendation may include first event information that characterizes the future time-limited event (e.g., the different contest may be longer or shorter, use different awards, etc.). The first event information may include a first event objective for the future time-limited event. Determination of the first event objective may be based on the determined one or more effects. The processor(s) may be configured to effectuate a first presentation to an event administrator (e.g., prompt the event administrator to hold another event, such as the different contest). The first presentation may include information based on one or more of the determined first recommendation, the first event information, the determined one or more effects, the first event objective, and/or other information.

Another aspect of the present disclosure relates to a method for using information obtained through time-limited events among quick service restaurants. The method may include obtaining sets of values of one or more service metrics that are related to service durations at a first quick service restaurant. Individual sets of values may correspond to individual periods during which the values may have been determined at the first quick service restaurant. The sets may include a first set, a second set, and/or other sets. The first set may correspond to a first period that occurred before a first time-limited event. The second set may correspond to a second period that occurred after the first period. The method may include analyzing the obtained set of values to determine one or more effects that are attributed to holding the first time-limited event. Individual ones of the one or more effects may correspond to one or more changes in the values of the one or more service metrics between the first set and the second set. The method may include determining a first recommendation for a future time-limited event to be held. Participants of the future time-limited event may include the first quick service restaurant. The first recommendation may include first event information that characterizes the future time-limited event. The first event information may include a first event objective for the future time-limited event. Determination of the first event objective may be based on the determined one or more effects. The method may include effectuating a first presentation to an event administrator. The first presentation may include information based on one or more of the determined first recommendation, the first event information, the determined one or more effects, the first event objective, and/or other information.

As used herein, any association (or relation, or reflection, or indication, or correspondency) involving servers, processors, client computing platforms, timing information, service durations, events, periods, times, dates, contests, challenges, participants, service metrics, values for service metrics, ranking orders, user interfaces, presentations, representations, durations, completions, indicators, indications, persons, vehicles, results, awards, notifications, changes, recommendations, models, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect, both local and remote. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for using information obtained through time-limited events among quick service restaurants, in accordance with one or more implementations.

FIG. 2 illustrates a method for using information obtained through time-limited events among quick service restaurants, in accordance with one or more implementations.

FIG. 3 illustrates an exemplary user interface as may be provided to employees of a quick service restaurant after an event has been initiated by an event administrator.

FIG. 4A illustrates an exemplary graph depicting a statistical relation between an event characteristic and a service metric.

FIG. 4B illustrates an exemplary graph depicting a multi-variable statistical relation.

FIG. 5 illustrates an exemplary user interface for presentation of a recommendation, in accordance with one or more implementations.

### DETAILED DESCRIPTION

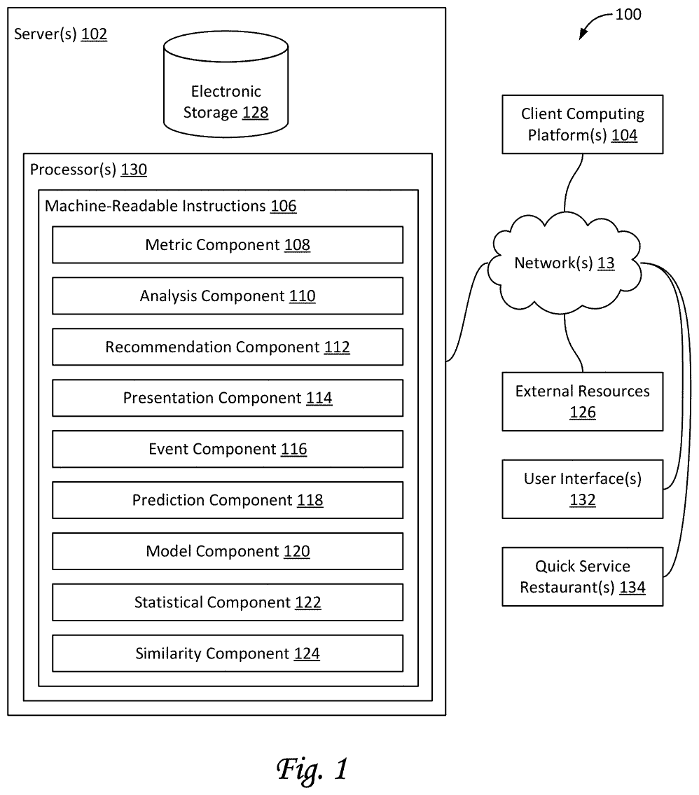

FIG. 1 illustrates a system 100 configured for using information obtained through time-limited events among quick service restaurants 134, in accordance with one or more implementations. Quick service restaurants 134 may include a first quick service restaurant, a second quick service restaurant, a third quick service restaurant, a fourth quick service restaurant, and so forth. The time-limited events may include a first event, a second event, a third event, a fourth event, and so forth. User interfaces 132 may include a first user interface associated with the first quick service restaurant, a second user interface associated with the second quick service restaurant, a third user interface associated with the third quick service restaurant, and so forth. The first user interface may be configured to present information to the employees of the first quick service restaurant. The second user interface may be configured to present information to the employees of the second quick service restaurant, and so forth. The information presented on the first interface may include information about service metrics and/or other performance indicators pertaining to the operation of the first quick service restaurant. Additionally, the presented information may include external information about external service metrics and/or other external performance indicators pertaining to the operation of other quick service restaurants (i.e., other than the first quick service restaurant). For example, the first user interface could present a ranking of the total number of customers served this week, month, or year, for multiple quick service restaurants 134. In some implementations, such a presentation may be referred to as a leaderboard.

In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104, one or more user interfaces 132, and/or one or more other components of system 100.

Server(s) 102 may be configured by machine-readable instructions 106. Machine-readable instructions 106 may include one or more instruction components. The instruction components may include computer program components. The instruction components may include one or more of metric component 108, analysis component 110, recommendation component 112, presentation component 114, event component 116, prediction component 118, model component 120, statistical component 122, similarity component 124, and/or other instruction components.

Metric component 108 may be configured to determine and/or obtain sets of values of one or more service metrics that are related to service durations at quick service restaurants 134, e.g., through aggregation, averaging, derivations, etc. In some implementations, metric component 108 may be configured to determine and/or obtain sets of values of one or more performance indicators that are related to the operation and/or performance of at quick service restaurants 134. For example, performance indicators may be monetary indicators and/or other business indicators. In some implementations, service metrics may be based on service timing information. In some implementations, service metrics and/or service timing information may be based on service durations for individual instances of service being provided at quick service restaurant 134.

Service durations may be defined by the time between a (service) start time or begin time and a (service) stop time or end time. In some implementations, an individual quick service restaurant 134 may be a drive-thru restaurant. In some implementations, the start time may be defined as the moment a particular vehicle enters the drive-thru (e.g., passes a particular point on the road surface of the drive-thru). In some implementations, the start time may be defined as the moment people in the particular vehicle begin or complete their order, or pay for their order. In some implementations, the end time of a service duration may be defined as the moment particular vehicle exits the drive-thru (e.g., passes a particular point on the road surface of the drive-thru). In some implementations, the end time may be defined as the moment people in a particular vehicle receive their order, or pay for their order. Start times and end times for different customers may be interleaved, such that individual service durations partially overlap with other service durations. Service durations may include a first service duration, a second service duration, a third service duration, and so forth. Vehicles may include a first vehicle, a second vehicle, a third vehicle, and so forth. In some implementations, individual instances of service being provided at a particular quick service restaurant 134 may include a first instance of service being provided to a first person in the first vehicle, a second instance of service being provided to one or more people in the second vehicle, and so forth. In some implementations, sets of values determined and/or obtained by metric component 108 may correspond to periods (e.g., day parts, days, weeks, months, years, etc.) that occurred before, during, or after events, such as time-limited events.

Events may include a first event, a second event, a third event, and so forth. In some implementations, events may include one or more contests, challenges, and/or other competitions. Events may be defined by event information. In some implementations, the event information may include one or more of event timing information, event participant information, event objective information for the event, event award information, and/or other information related to one or more events. Event timing information may specify one or more of an event start date, an event stop date, an event start time, an event stop time for the event, and/or other information related to event timing. By way of non-limiting example, the event timing information for an individual event may specify an event start time and an event stop time for the event, thereby defining an event duration between the event start time and the event stop time. In some implementations, the event timing information may specify an event start date and an event stop date, thereby defining an event date range. For example, the first event may be associated with a first event duration, the second event may be associated with the second event duration, the third event may be associated with the third event duration, and so forth. In some implementations, the event duration may be defined as a duration between 2 and 4 hours.

In some implementations, individual events may span multiple days. For example, a particular event may last a week, a month, or another multi-day period. In some implementations, a particular event may include individual rounds of competition occurring on different days. For example, a first contest may span every Friday from 11 a.m. to 2 p.m. for 3 months. For example, a second contest may span every Monday through Thursday from 6 a.m. to 10 a.m. for 2 months. For example, a third contest may span every Saturday and Sunday from 9 a.m. to 11 a.m., between an event start date and an event stop date that are about 10 weeks apart. In these examples, the portion of the contest that falls on a single day may be referred to as a round, or a daily round.

Event participant information may identify individual quick service restaurants that participated in one or more events. For example, a particular event may have included a particular quick service restaurant 134 and one or more other quick service restaurants (e.g., operated by the same franchisee, located in the same geographical region, owned by the same owner, and/or otherwise having one or more characteristics in common). For a particular event, the set of quick service restaurants that participated in the particular event may be referred to as the participating quick service restaurants or as the set of participating quick service restaurants.

Event award information may specify and/or identify one or more awards that can potentially be earned by and/or awarded to the individual quick service restaurants participating in a particular event. Some awards may be solely based on one or more service metrics for a single quick service restaurant. Some awards may be based on comparing one or more service metrics among multiple quick service restaurants (e.g., all participating quick service restaurants). Some awards may require a combination of two or more (sequential and/or contemporaneous) accomplishments.

Event objective information may specify one or more service metrics on which individual ones of the participating quick service restaurants competed during a particular event. In some implementations, event objective information may specify a service metric that was used to rank individual ones of the participating quick service restaurants during or after a particular event. In some implementations, service metrics may be based on service timing information. In some implementations, service metrics and/or service timing information may be based on service durations for individual instances of service being provided at quick service restaurant 134.

In some implementations, one or more service metrics may include one or more of average service duration per instance of service provided at an individual quick service restaurant, percentage of the instances of service provided for which the service duration was at or below a service duration goal, number of instances of service provided at an individual quick service restaurant, and/or percentage reached of a goal number of instances of service being provided at an individual quick service restaurant. In some implementations, one or more service metrics may be based (at least in part) on information from the one or more points-of-sale (e.g., total sales, average sales per instance of service, etc.). Service metrics that combine service duration and information from a point-of-sale (POS) are envisioned within the scope of this disclosure. Determining the values of the one or more service metrics may be performed (e.g., by individual quick service restaurants) during the event duration, during a predetermined time period, at the completion of the event duration, and/or at the completion of the predetermined time period. For example, the average service duration per instance of service provided at a particular quick service restaurant 134 for the first contest (described above) may have been determined by adding any service durations for instances of service provided on a Friday between 11 a.m. and 2 p.m., and dividing this total duration by the number of these instances.

In some implementations, metric component 108 may obtain multiple sets of values of service metrics corresponding to periods before, during, and/or after particular time-limited events for a particular quick service restaurant. For example, a first set of values may include the average service duration in the month prior to a first event, a second set of values may include the average service duration during the first event, and a third set of values may include the average service duration in the month after completion of the first event. Analysis of these three sets (e.g., by analysis component 110) may reveal short-term effects of holding the first event (e.g., a 20% decrease in average service duration during the first event), and longer-term effects of holding the first event (e.g., a 10% in average service duration when comparing the month before the first event to the month after the first event). A collection of multiple sets of values may be referred to as a superset of values.

In some implementations, metric component 108 may obtain multiple supersets of values of service metrics corresponding to periods before, during, and/or after multiple time-limited events for a particular quick service restaurant. For example, a first superset may include average service durations before, during, and after a first event, a second superset may include average service durations before, during, and after a second event, and so on. Analysis on multiple supersets (e.g., by analysis component 110) may reveal different effects that correspond and/or correlate to different characteristics of the particular events. For example, in some instances (for some quick service restaurants) week-long events may have little or no effect a month after the event, whereas month-long events may have longer-lasting effects, and 90-day-long events may have less long-term results than month-long events. Analysis of multiple supersets for different quick service restaurants may indicate a restaurant-specific preferable duration for events. For example, a first quick service restaurant may respond best to 10-day events, whereas a second quick service restaurant responds best to 3-week events. Accordingly, future events may be customized to use preferable restaurant-specific event characteristics. A collection of multiple supersets of values for different quick service restaurants may be referred to as a cluster-set of values, or a mega-superset of values.

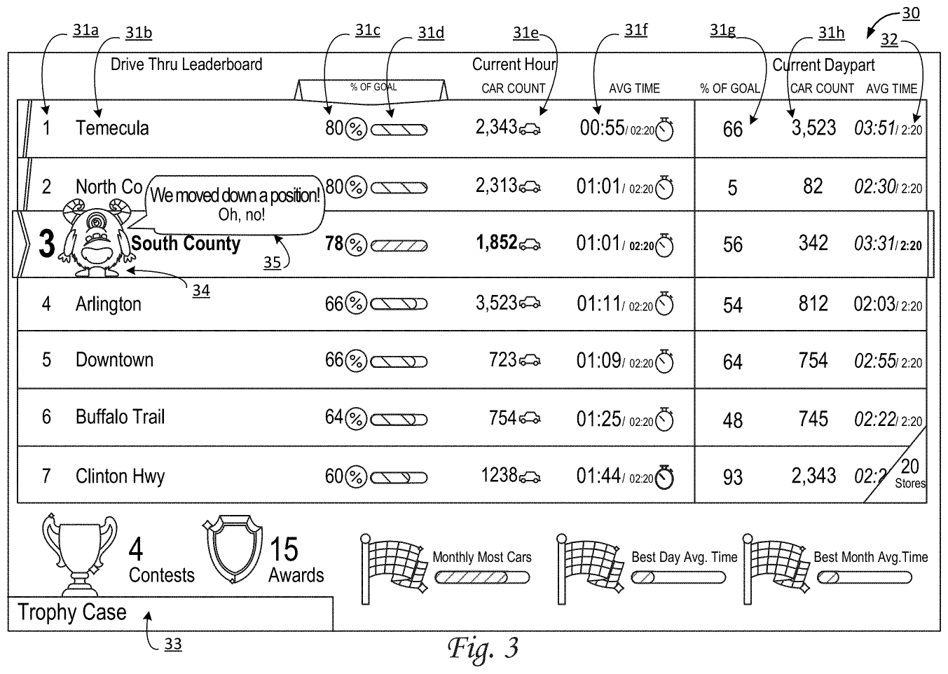

By way of non-limiting example, FIG. 3 illustrates an exemplary user interface 30 as may be presented to an individual quick service restaurant upon initiation of a particular event. As depicted in user interface 30, information related to an individual quick service restaurant is presented horizontally in a row. Each row includes values of service metrics and/or information derived therefrom. These values may be obtained by metric component 108. For example, an element 31a depicts a ranking in a ranking order. An element 31b depicts a name or identifier of an individual quick service restaurant. An element 31c depicts a service metric for the percentage of the instances of service being provided for which the service duration is at or below a service duration goal. Depending on whether the nature of the goal is a minimum or a maximum quantity, meeting a goal may be defined as reaching a metric and/or result that is below the goal, at or below the goal, at the goal, at or above the goal, or above the goal. An element 31d depicts a progress bar related to a service metric goal. An element 31e depicts the number of instances of service that have been provided at the quick service restaurant. An element 31f depicts an average service duration per instance of service being provided at the quick service restaurant (next to a service duration goal). An element 31g depicts a service metric for the percentage of the instances of service being provided for which the service duration is at or below a service duration goal. An element 31h depicts the number of instances of service that have been provided at the quick service restaurant. An element 32 depicts an average service duration per instance of service being provided at the quick service restaurant (next to a service duration goal). Elements 31c, 31d, 31e, and 31f may be associated with a particular time period or duration, such as, e.g., a current hour. Elements 31g, 31h, and 32 may be associated with a different time period or duration, such as, e.g., a current daypart. An element 33 depicts a trophy case for the “South County” quick service restaurant, which has ranking 3. For example, the quick service restaurant identified as “Temecula” is currently in first place, and “North County” is in second place, based on the values for the particular service metric being used to determine the ranking order. User interface 30 may be associated with the “South County” quick service restaurant, as is visually indicated by, e.g., the font size used for ranking element 31a in the depicted ranking order. An individual quick service restaurant may be associated with an avatar or character, here depicted as avatar 34. The information presented in each row may depict the current status of the particular event (here, a contest). For example, information 35 may be depicted subsequent to a change in the ranking order (here, “South County” moved down from ranking second to ranking third). Information 35 may include context-specific feedback provided in real-time (or with minimum delay), which may be based on a change in value of one or more service metrics. Here, information 35 may be based on the relative ranking order for multiple quick service restaurants. The number of rows and columns depicted is exemplary and not intended to be limiting in any way. At completion of the particular event (or a round of the particular event), one or more service metrics may be determined, recorded and subsequently obtained by metric component 108 and/or other components of system 100.

Referring to FIG. 1, analysis component 110 may be configured to analyze the obtained sets of values to determine one or more effects that are attributed to holding particular time-limited events. For example, an effect may correspond to a decrease in average service duration per instance of service being provided at a particular quick service restaurant. As used herein, the term “attributed” may also be interpreted as attributable, i.e., as having a reasonable likelihood of being attributed. Individual ones of the one or more effects may correspond to one or more changes in the values of one or more service metrics between different sets of values. In some implementations, analyzing the obtained sets of values may include quantifying a performance boost (e.g., in revenue per day) that may be attributed to holding a particular time-limited event.

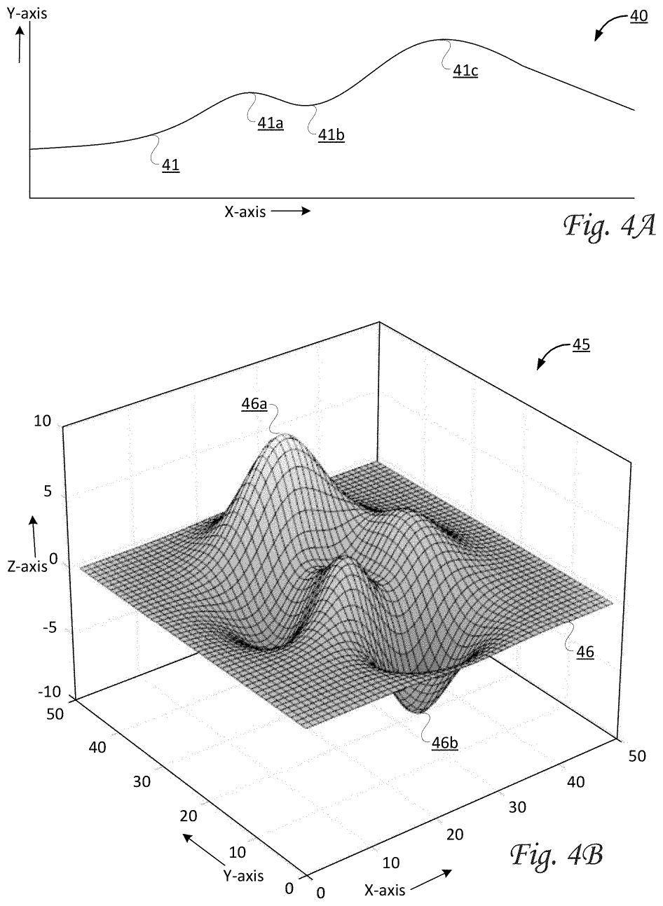

By way of non-limiting example, FIG. 4A illustrates an exemplary graph 40 depicting a statistical relation 41 between an event characteristic (on the X-axis) and a service metric (on the Y-axis). For example, the event characteristic may be the daily duration of a particular event, the number of days of a particular event, the value of awards available for a particular event, the number of times context-specific feedback was provided during a particular event, the number of times restaurant-to-restaurant communication (e.g., taunting, boasting, congratulations) occurred during a particular event, the number of participating quick service restaurants for a particular event, the (number of) resulting awards won at completion of the particular event, the resulting ranking order at completion of the particular event, and/or other information related to event information or any other event characteristic. The service metric may be the average service duration (e.g., during a particular event, or in the week after an event, or the month after an event, etc.), percentage of the instances of service provided for which the service duration was at or below a service duration goal, the number of instances of service provided during the particular event, the average daily number of instances of service provided in the week after the particular event (or the two weeks, or the month, etc.), and/or another metric. As depicted in FIG. 4A, statistical relation 41 may reveal a local maximum 41a, a local minimum 41b, and a global maximum 41c. Analysis of statistical relation 41 may reveal preferable event characteristics, e.g., for a particular quick service restaurant, for a particular crew at a quick service restaurant, for a particular manager at a quick service restaurant, for a collection of quick service restaurants, and/or for another entity pertinent to one or more quick service restaurants.

Referring to FIG. 1, in some implementations, analysis component 110 may be configured to perform statistical analyses, including but not limited to linear regression, non-linear regression, multivariate statistics, and/or other techniques (e.g., as provided by statistical component 122) to make determinations.

Recommendation component 112 may be configured to determine recommendations for future events to be held. The recommendations may be based on information from analysis component 110, statistical component 122, and/or other components of system 100, including but not limited to one or more preferable restaurant-specific event characteristics. The recommendations may include event information such as event timing information, event participant information, event objective information, event award information, and/or other information related to events.

Presentation component 114 may be configured to effectuate presentations to users, including but not limited to event administrators. For example, a first presentation may include information based on a determined performance boost (due to a previously-held event). For example, a second presentation may include information based on a determined recommendation (by recommendation component 112), and/or any of the corresponding event information included in a recommendation. For example, a presentation may include one or more preferable restaurant-specific event characteristics as determined by system 100.

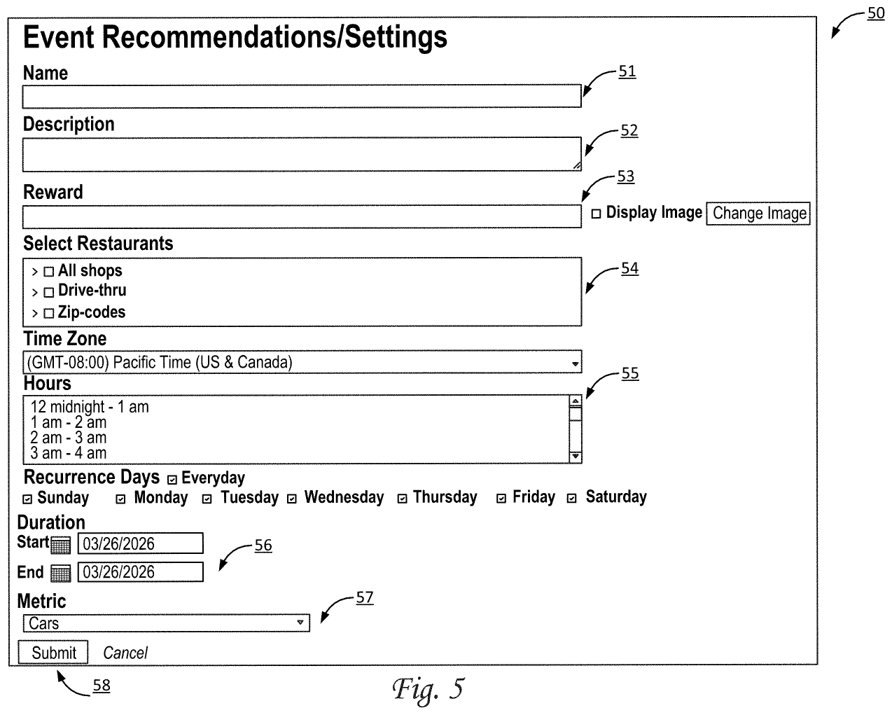

By way of non-limiting example, FIG. 5 illustrates an exemplary user interface 50 for presenting a recommendation to, e.g., an event administrator. As depicted, recommended event information may be presented via exemplary user interface 50. As depicted, element 51 and element 52 may be used to suggest or provide a name and description for a potential new event. Element 53 may be used to recommend an award for the potential new event. Element 54 may be used to recommend event participant information. Element 55 may be used to recommend an event start time and an event stop time. Element 56 may be sued to recommend an event start date and an event end date. Element 57 may be used to recommend one or more service metrics to be used for ranking associated with the potential new event. Element 58 may be used to submit, initiate, launch, and/or otherwise start the potential new event as recommended though user interface 50.

Referring to FIG. 1, event component 116 may be configured to initiate a new time-limited event based on a determined recommendation, e.g., as illustrated element 58 in FIG. 5. User may modify recommended event information prior to initiating new events.

Prediction component 118 may be configured to predict expected sets of values of one or more service metrics for future events at quick service restaurants 134. In some implementations, an expected set of values may correspond to a new potential event as recommended (by recommendation component 112). Predictions may be based on a model for one or more quick service restaurants.

Model component 120 may be configured to create and/or modify a model for one or more quick service restaurants. In some implementations, modifications may be based on comparisons between expected sets of values and actual (i.e. measured) sets of values. In some implementations, models may be specific to individual quick service restaurants.

Statistical component 122 may be configured to determine one or more differences and/or distinctions between different effects that are attributed to holding different events. In some implementations, determining the one or more particular differences and/or distinctions may include quantifying an effect that is attributed to ranking order (or any other event-specific result) at completion of different events. For example, ranking second may have better long-term effects than ranking first for some quick service restaurants, or vice versa. In some implementations, multiple input variables (such as particular selections for event information) may interact in producing (performance) results for a particular quick service restaurant. In some implementations, multiple input variables may be independent of each other.

By way of non-limiting example, FIG. 4B illustrates an exemplary graph 45 depicting a statistical relation 46 between a first event characteristic (on the X-axis), a second event characteristic (on the Y-axis), and a service metric or performance metric (on the Z-axis). Values may have been normalized such that the range is 0-50 for the X-axis and Y-axis, and −10 to 10 for the Z-axis. For example, the first or second event characteristic may be the daily duration of a particular event, the number of days of a particular event, the value of awards available for a particular event, the number of times context-specific feedback was provided during a particular event, the number of times restaurant-to-restaurant communication (e.g., taunting, boasting, congratulations) occurred during a particular event, the number of participating quick service restaurants for a particular event, the (number of) resulting awards won at completion of the particular event, the resulting ranking order at completion of the particular event, and/or other information related to event information or any other event characteristic. The service metric or performance metric may be the average service duration (e.g., during a particular event, or in the week after an event, or the month after an event, etc.), percentage of the instances of service provided for which the service duration was at or below a service duration goal, the number of instances of service provided during the particular event, the average daily number of instances of service provided in the week after the particular event (or the two weeks, or the month, etc.), revenue per day, and/or another metric. As depicted in FIG. 4B, statistical relation 46 may reveal a global maximum 46a and a global minimum 46b, as well as several local maxima and minima. Analysis of statistical relation 46 may reveal preferable combinations of event characteristics, e.g., for a particular quick service restaurant, for a particular crew at a quick service restaurant, for a particular manager at a quick service restaurant, for a collection of quick service restaurants, and/or for another entity pertinent to one or more quick service restaurants.

Referring to FIG. 1, similarity component 124 may be configured to determine whether two or more different quick service restaurants are similar. For example, similarity may be based on service metrics, on business indicators, on demographic information, and/or other information. For example, store “A” may be similar to store “B” based on the average number of cars served per day. Additionally, store “A” may be similar to store “C” based on the percentage of the instances of service provided for which the service duration was at or below a service duration goal. Assume a new contest was held including store “B” and store “C”. Based on the current model for store “A”, and the results of the new contest at stores “B” and “C”, system 100 may be configured to predict an expected result of a similar contest if it were held at store “A”, the prediction being based at least in part on the similarities of these stores. In some implementations, the actual results of that similar contest (assuming it was actually held) may be subsequently used to modify the model for store “A”, and/or re-determine the similarities of store “A” with other stores.

In some implementations, server(s) 102, client computing platform(s) 104, and/or external resources 126 may be operatively linked via one or more electronic communication links. For example, such electronic communication links may be established, at least in part, via one or more networks 13 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, 118, 120, 122, and/or 124, and/or other components. Processor(s) 130 may be configured to execute components 108, 110, 112, 114, 116, 118, 120, 122, and/or 124, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 122, and/or 124 are illustrated in FIG. 1 as being implemented within a single processing unit, in implementations in which processor(s) 130 includes multiple processing units, one or more of components 108, 110, 112, 114, 116, 118, 120, 122, and/or 124 may be implemented remotely from the other components. The description of the functionality provided by the different components 108, 110, 112, 114, 116, 118, 120, 122, and/or 124 described below is for illustrative purposes, and is not intended to be limiting, as any of components 108, 110, 112, 114, 116, 118, 120, 122, and/or 124 may provide more or less functionality than is described. For example, one or more of components 108, 110, 112, 114, 116, 118, 120, 122, and/or 124 may be eliminated, and some or all of its functionality may be provided by other ones of components 108, 110, 112, 114, 116, 118, 120, 122, and/or 124. As another example, processor(s) 130 may be configured to execute one or more additional components that may perform some or all of the functionality attributed below to one of components 108, 110, 112, 114, 116, 118, 120, 122, and/or 124.

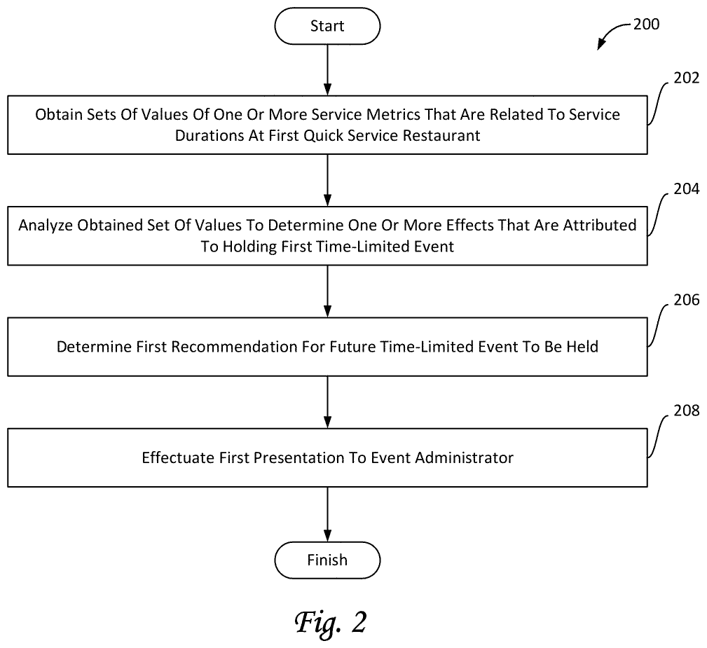

FIG. 2 illustrates a method 200 for using information obtained through time-limited events among quick service restaurants, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include obtaining sets of values of one or more service metrics that are related to service durations at a first quick service restaurant. Individual sets of values correspond to individual periods during which the values may have been determined at the first quick service restaurant. The sets may include a first set and a second set. The first set may correspond to a first period that occurred before a first time-limited event. The second set may correspond to a second period that occurred after the first period. Operation 202 may be performed by one or more hardware processors configured by machine-readable instructions including a component that is the same as or similar to metric component 108, in accordance with one or more implementations.

An operation 204 may include analyzing the obtained set of values to determine one or more effects that are attributed to holding the first time-limited event. Individual ones of the one or more effects correspond to one or more changes in the values of the one or more service metrics between the first set and the second set. Operation 204 may be performed by one or more hardware processors configured by machine-readable instructions including a component that is the same as or similar to analysis component 110, in accordance with one or more implementations.

An operation 206 may include determining a first recommendation for a future time-limited event to be held. Participants of the future time-limited event may include the first quick service restaurant. The first recommendation may include first event information that characterizes the future time-limited event. The first event information may include a first event objective for the future time-limited event. Determination of the first event objective may be based on the determined one or more effects. Operation 206 may be performed by one or more hardware processors configured by machine-readable instructions including a component that is the same as or similar to recommendation component 112, in accordance with one or more implementations.

An operation 208 may include effectuating a first presentation to an event administrator. The first presentation may include information based on one or more of the determined first recommendation. The first event information, the may be determined one or more effects, and/or the first event objective. Operation 208 may be performed by one or more hardware processors configured by machine-readable instructions including a component that is the same as or similar to presentation component 114, in accordance with one or more implementations.

In some implementations, a system as described in this disclosure may be used for customer-oriented businesses that are not quick service restaurants, provided there are defined moments an instance of service being provided starts and ends. Stores, pharmacies, medical offices, and/or other types of customer-oriented businesses may measure service durations and used these measurements to define service metrics and/or other metrics, which may in turn form the basis for the definition of time-limited events, ranking orders, one or more user interfaces similar to the user interfaces described above, one or more awards, and/or any other entity or object described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for using information obtained through time-limited events among quick service restaurants, the system comprising:
one or more hardware processors configured by machine-readable instructions to:
obtain sets of values of one or more service metrics that are related to service durations at a first quick service restaurant, wherein individual sets of values correspond to individual periods during which the values have been determined at the first quick service restaurant, wherein the sets include a first set and a second set, wherein the first set corresponds to a first period that occurred before a first time-limited event, and wherein the second set corresponds to a second period that occurred after the first period;
analyze the obtained set of values to determine one or more effects that are attributed to holding the first time-limited event, wherein individual ones of the one or more effects correspond to one or more changes in the values of the one or more service metrics between the first set and the second set;
determine a first recommendation for a future time-limited event to be held, wherein participants of the future time-limited event include the first quick service restaurant, and wherein the first recommendation includes first event information that characterizes the future time-limited event, wherein the first event information includes a first event objective for the future time-limited event, and wherein determination of the first event objective is based on the determined one or more effects; and
effectuate a first presentation to an event administrator, wherein the first presentation includes information based on one or more of the determined first recommendation, the first event information, the determined one or more effects, and/or the first event objective.

2. The system of claim 1, wherein a first effect corresponds to a decrease in average service duration per instance of service being provided at the first quick service restaurant.

3. The system of claim 1, wherein the one or more hardware processors are further configured by machine-readable instructions to:
initiate a new time-limited event based on the determined first recommendation;
predict expected sets of values of the one or more service metrics that are related to service durations at the first quick service restaurant, wherein the expected sets correspond to the new time-limited event, wherein prediction is based on a model for the first quick service restaurant;
obtain actual sets of values of the one or more service metrics that are related to service durations at the first quick service restaurant, wherein the actual sets correspond to the new time-limited event; and
modify the model based on a comparison between the expected sets of values with the actual sets of values.

4. The system of claim 1, wherein analyzing the obtained set of values includes quantifying a performance boost that is attributed to holding the first time-limited event, wherein the first presentation includes information based on the determined performance boost.

5. The system of claim 1, wherein the sets further include a third set and a fourth set, wherein the third set corresponds to a third period that occurred before a second time-limited event, and wherein the fourth set corresponds to a fourth period that occurred after the third period;
wherein the one or more hardware processors are further configured by machine-readable instructions to determine one or more differences between effects that are attributed to holding the first time-limited event and effects that are attributed to holding the second time-limited event;
wherein the one or more hardware processors are further configured by machine-readable instructions to determine a second recommendation for a second future time-limited event to be held, wherein the second recommendation includes second event information that characterizes the second future time-limited event, wherein the second event information includes a second event objective for the second future time-limited event, and wherein determination of the second event objective is based on the determined one or more differences;
wherein the one or more hardware processors are further configured by machine-readable instructions to effectuate a second presentation to the event administrator, wherein the second presentation includes information based on the determined second recommendation and the determined one or more differences.

6. The system of claim 1, wherein the one or more hardware processors are further configured by machine-readable instructions to:
obtain additional sets of values of the one or more service metrics that are related to service durations at a second quick service restaurant, wherein individual additional sets of values correspond to individual periods during which the values have been determined at the second quick service restaurant, wherein the additional sets correspond to periods that occurred before and after one or more additional events;
determine one or more particular differences between effects that are attributed to holding the first time-limited event and effects that are attributed to holding the one or more additional events;
determine a third recommendation for a third future time-limited event to be held, wherein the third recommendation includes third event information that characterizes the third future time-limited event, wherein the third event information includes a third event objective for the third future time-limited event, and wherein determination of the third event objective is based on the determined one or more particular differences;
effectuate a third presentation to the event administrator, wherein the third presentation includes information based on the determined third recommendation.

7. The system of claim 6, wherein determining the one or more particular differences includes quantifying an effect that is attributed to ranking order at completion of one or more of the first time-limited event and the one or more additional events.

8. The system of claim 1, wherein the one or more hardware processors are further configured by machine-readable instructions to:
obtain supplemental sets of values of the one or more service metrics that are related to service durations at a third quick service restaurant, wherein individual supplemental sets of values correspond to individual periods during which the values have been determined at the third quick service restaurant, wherein the supplemental sets correspond to periods that occurred before and after one or more supplemental events;
determine one or more distinctions between effects that are attributed to holding the one or more supplemental events and effects that are attributed to holding the one or more additional events;
determine a fourth recommendation for a fourth future time-limited event to be held, wherein the fourth recommendation includes fourth event information that characterizes the fourth future time-limited event, wherein the fourth event information includes a fourth event objective for the fourth future time-limited event, and wherein determination of the fourth event objective is based on the determined one or more distinctions;
effectuate a fourth presentation to the event administrator, wherein the fourth presentation includes information based on the determined fourth recommendation.

9. The system of claim 1, wherein the one or more hardware processors are further configured by machine-readable instructions to:
initiate a particular time-limited event based on the determined fourth recommendation;
predict expected sets of values of the one or more service metrics that are related to service durations at the first quick service restaurant, wherein the expected sets correspond to the particular time-limited event, wherein prediction is based on a model for the first quick service restaurant;
obtain actual sets of values of the one or more service metrics that are related to service durations at the first quick service restaurant, wherein the actual sets correspond to the particular time-limited event; and
modify the model based on a comparison between the expected sets of values with the actual sets of values.

10. The system of claim 9, wherein the fourth presentation includes information regarding the modified model.

11. A method for using information obtained through time-limited events among quick service restaurants, the method comprising:
obtaining sets of values of one or more service metrics that are related to service durations at a first quick service restaurant, wherein individual sets of values correspond to individual periods during which the values have been determined at the first quick service restaurant, wherein the sets include a first set and a second set, wherein the first set corresponds to a first period that occurred before a first time-limited event, and wherein the second set corresponds to a second period that occurred after the first period;
analyzing the obtained set of values to determine one or more effects that are attributed to holding the first time-limited event, wherein individual ones of the one or more effects correspond to one or more changes in the values of the one or more service metrics between the first set and the second set;
determining a first recommendation for a future time-limited event to be held, wherein participants of the future time-limited event include the first quick service restaurant, and wherein the first recommendation includes first event information that characterizes the future time-limited event, wherein the first event information includes a first event objective for the future time-limited event, and wherein determination of the first event objective is based on the determined one or more effects; and
effectuating a first presentation to an event administrator, wherein the first presentation includes information based on one or more of the determined first recommendation, the first event information, the determined one or more effects, and/or the first event objective.

12. The method of claim 11, wherein a first effect corresponds to a decrease in average service duration per instance of service being provided at the first quick service restaurant.

13. The method of claim 11, further comprising:
initiating a new time-limited event based on the determined first recommendation;
predicting expected sets of values of the one or more service metrics that are related to service durations at the first quick service restaurant, wherein the expected sets correspond to the new time-limited event, wherein prediction is based on a model for the first quick service restaurant;
obtaining actual sets of values of the one or more service metrics that are related to service durations at the first quick service restaurant, wherein the actual sets correspond to the new time-limited event; and
modifying the model based on a comparison between the expected sets of values with the actual sets of values.

14. The method of claim 11, wherein analyzing the obtained set of values includes quantifying a performance boost that is attributed to holding the first time-limited event, wherein the first presentation includes information based on the determined performance boost.

15. The method of claim 11, wherein the sets further include a third set and a fourth set, wherein the third set corresponds to a third period that occurred before a second time-limited event, and wherein the fourth set corresponds to a fourth period that occurred after the third period;
determining one or more differences between effects that are attributed to holding the first time-limited event and effects that are attributed to holding the second time-limited event;
determining a second recommendation for a second future time-limited event to be held, wherein the second recommendation includes second event information that characterizes the second future time-limited event, wherein the second event information includes a second event objective for the second future time-limited event, and wherein determination of the second event objective is based on the determined one or more differences;
effectuating a second presentation to the event administrator, wherein the second presentation includes information based on the determined second recommendation and the determined one or more differences.

16. The method of claim 11, further comprising:
obtaining additional sets of values of the one or more service metrics that are related to service durations at a second quick service restaurant, wherein individual additional sets of values correspond to individual periods during which the values have been determined at the second quick service restaurant, wherein the additional sets correspond to periods that occurred before and after one or more additional events;
determining one or more particular differences between effects that are attributed to holding the first time-limited event and effects that are attributed to holding the one or more additional events;
determining a third recommendation for a third future time-limited event to be held, wherein the third recommendation includes third event information that characterizes the third future time-limited event, wherein the third event information includes a third event objective for the third future time-limited event, and wherein determination of the third event objective is based on the determined one or more particular differences;
effectuating a third presentation to the event administrator, wherein the third presentation includes information based on the determined third recommendation.

17. The method of claim 16, wherein determining the one or more particular differences includes quantifying an effect that is attributed to ranking order at completion of one or more of the first time-limited event and the one or more additional events.

18. The method of claim 11, further comprising:
obtaining supplemental sets of values of the one or more service metrics that are related to service durations at a third quick service restaurant, wherein individual supplemental sets of values correspond to individual periods during which the values have been determined at the third quick service restaurant, wherein the supplemental sets correspond to periods that occurred before and after one or more supplemental events;
determining one or more distinctions between effects that are attributed to holding the one or more supplemental events and effects that are attributed to holding the one or more additional events;
determining a fourth recommendation for a fourth future time-limited event to be held, wherein the fourth recommendation includes fourth event information that characterizes the fourth future time-limited event, wherein the fourth event information includes a fourth event objective for the fourth future time-limited event, and wherein determination of the fourth event objective is based on the determined one or more distinctions;
effectuating a fourth presentation to the event administrator, wherein the fourth presentation includes information based on the determined fourth recommendation.

19. The method of claim 11, further comprising:
initiating a particular time-limited event based on the determined fourth recommendation;
predicting expected sets of values of the one or more service metrics that are related to service durations at the first quick service restaurant, wherein the expected sets correspond to the particular time-limited event, wherein prediction is based on a model for the first quick service restaurant;
obtaining actual sets of values of the one or more service metrics that are related to service durations at the first quick service restaurant, wherein the actual sets correspond to the particular time-limited event; and
modifying the model based on a comparison between the expected sets of values with the actual sets of values.

20. The method of claim 19, wherein the fourth presentation includes information regarding the modified model.
